(19) United States
(12) Patent Application Publication
(10) Pub. No.: US 2006/0059965 A1
(43) Pub. Date: Mar. 23, 2006

(54) Rekeyable lock having 2-piece pin with rotatable member

(76) Inventor: Evan A. Benstead, Los Angeles, CA (US)

Correspondence Address: Richard J. Veltman;c/o Black & Decker Corporation, 701 E. Joppa Road; TW-199, Towson, MD, 21286, US

(21) Appl. No.: 10/944,060

(22) Filed: Sep. 17, 2004

(51) Int. Cl. E05B 27/04

(52) U.S. Cl. 70/493; 70/383; 70/384

(57) ABSTRACT

A re-keyable lock cylinder assembly is provided which includes a cylinder housing and a cylinder plug rotatably supported in the cylinder housing. A tumbler pin assembly includes a pair of pins disposed and slidably supported within a pin bore formed in the cylinder plug and a coupling element interposed between the pair of pins and selectively rotatable between a coupled position wherein the pair of pins are fixed with respect to one another and a free position wherein the pair of pins are positionable with respect to one another for varying a height of the tumbler pin assembly.

### FIELD OF THE INVENTION

The present invention relates to lock cylinders, and more particularly, to an improved rekeyable lock cylinder.

### BACKGROUND OF THE INVENTION

It is well known in the art to provide a door hardware assembly that is operable to maintain a door in a closed position by selectively securing the door to a doorframe. It is equally well known to provide a door hardware assembly that is capable of being locked to selectively prevent operation of the door hardware assembly. As can be appreciated, by preventing operation of the door hardware assembly, the door will remain closed and in a locked condition. Such conventional door hardware assemblies generally include a handle assembly, lock cylinder, and key, whereby the key is operable to selectively lock the lock cylinder to prevent operation of the door handle assembly and maintain the door in the closed and locked condition.

The lock cylinder includes a cylinder plug rotatably supported in a cylinder housing. A set of pins extend between the cylinder plug and the cylinder housing to selectively lock and unlock the lock cylinder. The lock cylinder is designed to matingly receive a key, whereby the key is operable to change the lock cylinder between a locked and unlocked condition. As can be appreciated, the key is specific to the particular lock cylinder so as to prevent unwanted operation of the door handle assembly.

The lock cylinder commonly includes a plurality of pin assemblies, whereby each pin assembly includes an upper pin slidably disposed within an upper bore formed in the cylinder housing and a lower pin slidably disposed within a lower bore formed in the cylinder plug. A shear line is defined between the cylinder plug and cylinder housing. The key is used to selectively lock and unlock the lock cylinder, whereby raised portions or bitings disposed on the key are operable to engage the upper and lower pins to properly align the pin interface with shear line to permit rotation of the cylinder plug within the cylinder housing. It may be desirable to “reset” or “rekey” the lock cylinder, without having to replace the entire mechanism. Rekeying of a conventional lock cylinder provides the lock cylinder with a new key that is operable to lock and unlock the re-configured lock cylinder, while concurrently prohibiting further use of the old key.

In a re-keying operation, the upper and lower pins are replaced to vary the relative heights of each of the upper and lower pins which corresponds to the new key. In this regard, a new key having raised portions or bitings commensurate with the new pin heights of each pin assembly, is required to properly align the pin interface within the shear line. Once the new pins are installed, the lock cylinder will no longer permit rotation of the door handle assembly if the old key is used in the lock cylinder. As can be appreciated, the old key is not commensurate with the new pin heights, and therefore will not properly align the first and second shear zones of the respective pin assemblies.

While conventional lock cylinders adequately provide for a re-keying operation of a lock cylinder, they suffer from the disadvantage of requiring at least partial disassembly of the lock cylinder and typically require a specialized technician, such as a locksmith, to perform the re-keying operation. Further, conventional lock cylinders suffer from the disadvantage of requiring multiple pin heights and combinations thereof to properly re-key the cylinder. Further yet, conventional re-keying kits require door hardware manufacturers to produce varying pin heights for each kit, thereby overproducing the required number of individual pins to simply re-key one lock cylinder.

Therefore, a lock cylinder that provides for a re-keying operation without requiring disassembly of the lock cylinder is desirable in the industry. Furthermore, a lock cylinder that is capable of being re-keyed without replacing the existing components is also desirable. Further yet, a lock cylinder that provides for a re-keying operation without requiring a plurality of additional pins with varying pin heights is also desirable.

### SUMMARY OF THE INVENTION

In accordance with one aspect of the present invention, a lock cylinder is provided which includes a cylinder housing having a first bore formed along a first longitudinal axis, a cylinder plug rotatably disposed within the first bore, and a pin assembly disposed within the cylinder housing and the cylinder plug. The pin assembly is operable to selectively lock the inner cylinder relative to the outer cylinder. The pin assembly includes an upper pin disposed in a pin bore formed in the cylinder housing and a lower tumbler pin assembly having a pair of pins disposed and slidably supported within a pin bore formed in the cylinder plug. A coupling element is interposed between the pair of pins and selectively rotatable between a coupled position wherein the pair of pins are fixed with respect to one another and a free position wherein the pair of pins are positionable with respect to one another for varying a height of the tumbler pin assembly. A camming system is operably coupled between the cylinder housing and the tumbler pin assembly to enable selective rotation of the coupling elements between the coupled position and the free position.

In accordance with one aspect of the present invention, a method of rekeying a lock cylinder is provided in which a valid key is inserted into a keyway in a cylinder plug so that the cylinder plug can be rotated with respect to the cylinder housing from a home position to a learn position. A pin assembly within a pin bore formed in the cylinder plug is rotated from a fixed position to a free position such that a height defined by first and second pins of the pin assembly is adjusted. The valid key is extracted from the keyway and a replacement key is inserted into the keyway. The pin assembly is rotated within the pin bore to the coupled position to fix the height of the pin assembly. The cylinder plug is rotated to the home position and the replacement key is removed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a respective view of a lock cylinder in accordance with the present invention;

FIG. 2 is an exploded perspective view of the lock cylinder shown in FIG. 1;

FIG. 3 is an exploded detail view of a tumbler pin assembly in accordance with the present invention;

FIG. 3A is a cross-sectional view of the pin carrier shown in FIG. 3 taken along line A-A;

FIG. 3B is a cross-sectional view taken of through inner pin illustrated in FIG. 3 taken along line B-B;

FIG. 4 is a partial cross-sectional view of the lock cylinder illustrated in FIG. 1 taken along line 4-4;

FIG. 5 is a partial cross-sectional view of the lock cylinder shown in FIG. 1 taken along line 5-5;

FIG. 6 is a partial cross-sectional view similar to FIG. 4 in which the lock cylinder has been placed in the learn mode;

FIG. 7A is a partial perspective view of the lock cylinder illustrated in FIG. 1 rotated to a locking mode; and

FIG. 7B is a partial perspective view of the lock cylinder illustrated in FIG. 1 in a learn mode.

### DETAILED DESCRIPTION OF THE PREFERRED EMBODIMENTS

The following description of the preferred embodiment is merely exemplary in nature and is in no way intended to limit the invention, its application, or uses.

With reference now to the drawings, lock cylinder assembly 10 includes a cylinder housing 12 having a cylindrical cavity 14 formed along a longitudinal axis thereof and a cylinder plug 16 having a keyway 18 formed along the longitudinal axis thereof which is rotatably supported within the interior cavity 14 of the cylinder housing 12. A chimney 20 extends upwardly from cylinder body 22. A set of pin bores 24 extend through chimney 20 and terminate at interior cavity 14. Likewise, a set of pin bores 26 are formed in cylinder plug 16 to extend between keyway 18 and an outer surface of the cylinder plug 16. As previously indicated the cylinder 16 is rotatably supported within the cylinder housing 12 such that pin bores 24 formed in chimney 20 are aligned with pin bores 26 when the cylinder plug 16 is in a home position.

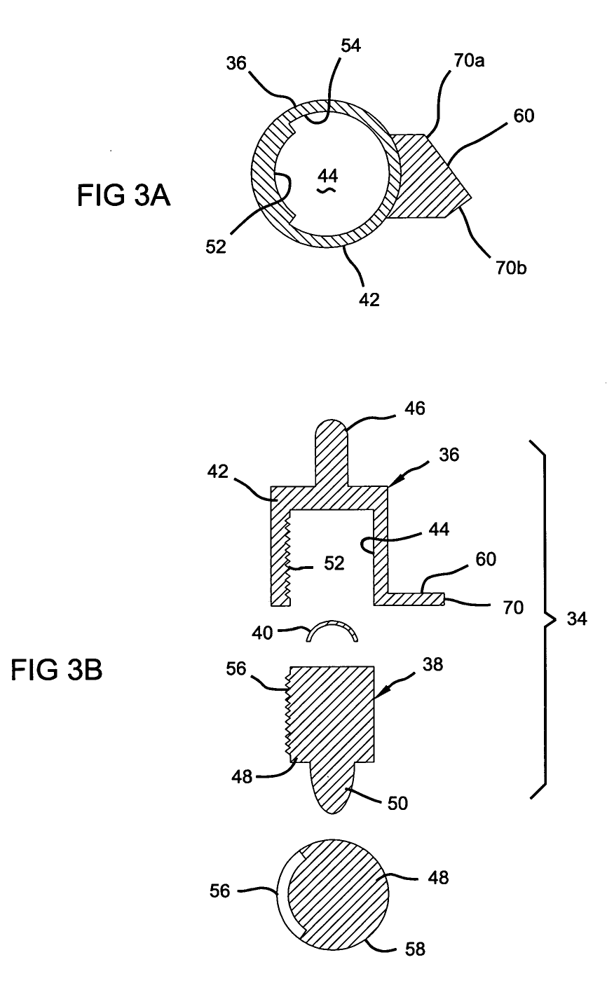

Lock Cylinder assembly 10 further includes a set of tumbler pins 28 and a set of springs 30 disposed and slidably supported within pin bore 24 at cylinder housing 12. A cap 32 is disposed on top of chimney 20 for releasbly retaining pins 28 and springs 30 therein. Another set of tumbler pin assemblies 34 are disposed and slidably supported within pin bore 26. As best seen in FIGS. 3, 3A and 3B, each of tumbler pin assemblies 34 includes a pin carrier 36 and a inner pin 38 having a spring 40 interposed therebetween. Pin carrier 36 includes a generally cylindrical carrier body 42 having a blind bore 44 formed therein and a pin 46 extending from an upper surface of the body 42. Inner pin 38 has a generally cylindrical pin body 48 adapted to be received within blind bore 44. Pin 50 extends downwardly from a lower surface of pin body 48.

Spring 40 is interposed between adjacent faces of carrier body 42 and pin body 48. As presently preferred, spring 40 takes the form of a generally unshaped leaf spring adapted to a flex within the confines of blind bore 44. However, one skilled in the art will recognize that other spring elements which provide an opposed biasing force between pin carrier 36 and inner pin 38 may be suitably employed in the present invention.

Pin carrier 36 may be selectively rotatable with respect to inner pin 38 on pin body 48. A coupling element is interposed between the pin carrier 36 and the inner pin 38 which in a coupled position, the coupling element affixes the inner pin 38 with respect to the pin carrier 36 such that the overall height of the tumbler pin assembly 34 is fixed. Pin carrier 36 may be rotated relative to inner pin 38 to an uncoupled or free position. In the free position, the pin carrier 36 and the inner pin 38 may slide axially within pin bore 26 independent of one another, thereby allowing for adjustment of the pin height of pin tumbler assembly 34.

As presently preferred, the coupling element takes the form of an arcuate gear set. Specifically with reference to FIG. 3A, a gear-like rack 52 is formed on an inner surface 54 defined by blind bore 44. The arcuate rack 52 extends approximately 90° around the inner surface 54. A complimentary gear rack 56 is formed in an outer surface 58 of pin body 48 over approximately 90° of the outer surface 58. Thus, pin carrier 36 may be rotated relative to inner pin 38 through approximately 90° for coupling and uncoupling the tumbler pin assembly 34.

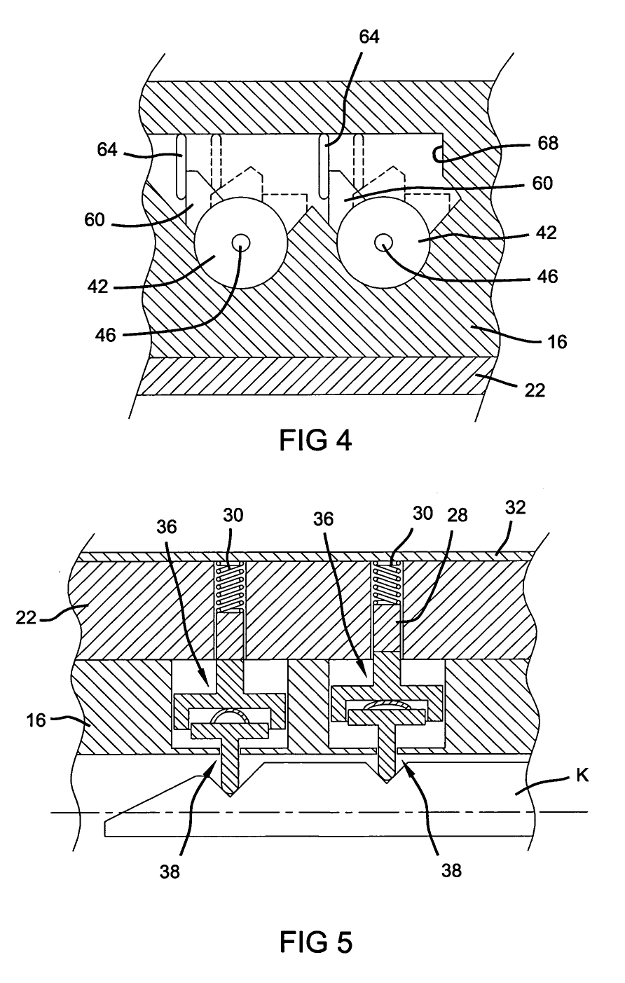

Pin carrier 36 has a cam arm 60 extending from carrier body 42. A comb 62 having a set of fingers 64 extends through a set of apertures 66 formed in cylinder housing 22 and a set of apertures 68 formed in cylinder plug 16 so as to engage cam arm 60 as best seen in FIG. 4. Apertures 68 formed in cylinder plug 16 are generally L-shaped to afford relative rotation of the cylinder plug 16 within cylinder housing 12 and at the same time afford axial movement of the cylinder plug 16 within cylinder housing 12 when the lock cylinder 10 is in a learn mode. Specifically, with reference to FIG. 4, fingers 64 of comb 62 extend into cylinder plug 16 so as to engage cam surface 70a formed on cam arm 60. As cylinder plug 16 moves axially (to the left as shown in FIG. 4) with respect to housing body 22, fingers 64 cooperate with cam arm 70a to rotate pin carrier 36 (in a clockwise direction as shown in FIG. 4), thereby decoupling the inner pin 38 from the pin carrier 36. Likewise, axial movement of the cylinder plug 16 (to the right as shown in FIG. 16) causes the fingers 64 to engage cam surface 70b, thereby rotating the pin carrier 36 in a counterclockwise direction (as shown in FIG. 4) causing gear rack 52 to engage gear rack 56, and couple pin carrier 36 and inner pin 38.

Comb 72 is disposed on a side of housing body 22 opposite comb 62. Comb 72 has a set of fingers 74 extending therefrom which are adapted to be received through a set of apertures 76 formed in housing body 22 and a set of apertures 78 formed in cylinder plug 16. Fingers 74 extend through apertures 78 to impinge upon the pin carrier 36 and maintain the tumbler pin assembly 34 in a coupled position when the lock cylinder 10 and not the learn position (i.e., in the home position or the upright position).

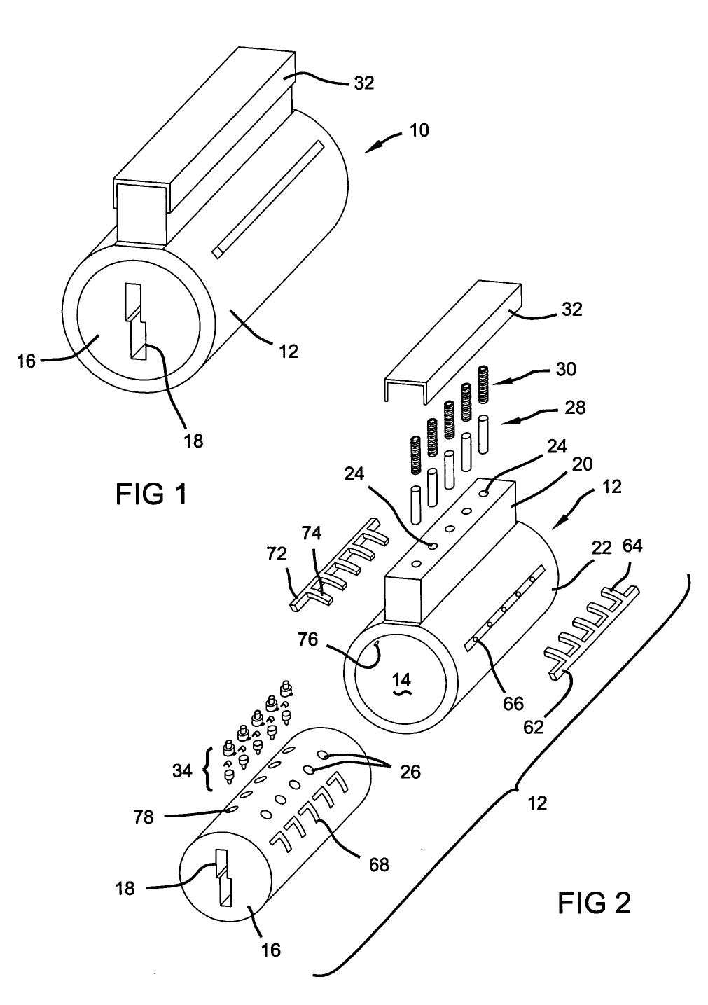

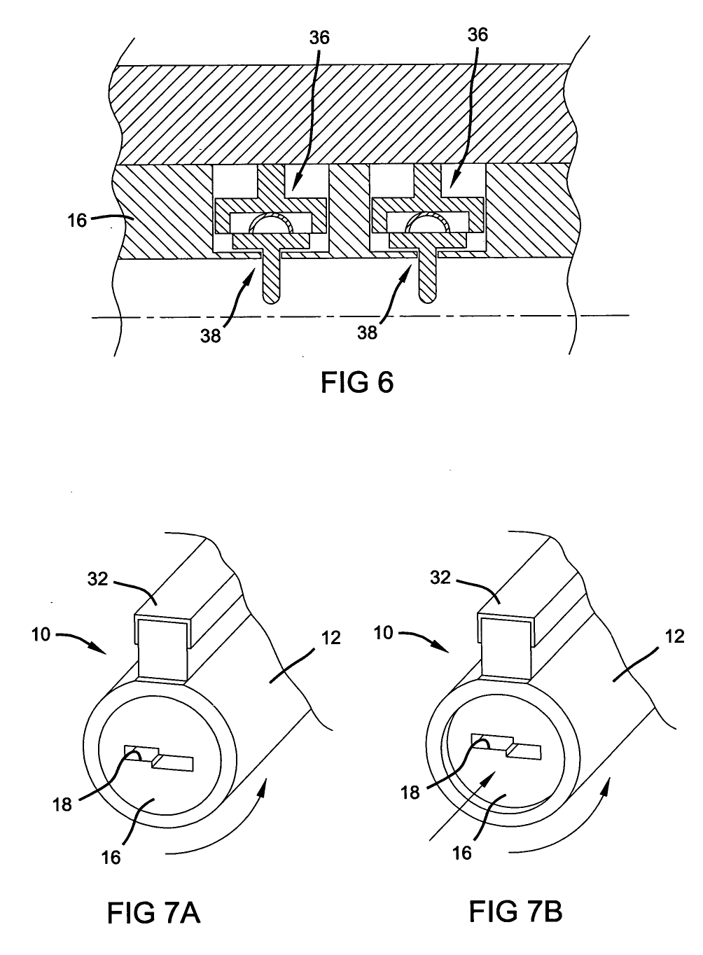

With reference now to FIGS. 1 and 5-7B, operation of lock cylinder 10 will now be described. Initially the lock cylinder 10 is in a home position as illustrated in FIG. 1. Upon insertion of key K into keyway 18, the pin extension 50 on tumbler pin assembly 34 cooperate with the bitings formed on the key K for positioning pins 28 and 34 within the lock cylinder 10. When an authorized key is inserted, the bitings in the key K correspond to the height of tumbler pin assembly 34 such that the interface between pin extension 46 and pin 28 align along the shear interfaces between the cylinder housing 12 and the lock plug 16. So aligned, the cylinder plug 16 may be rotated in a counter-clockwise direction relative to the cylinder housing 12 towards an operation position (as best shown in FIG. 7A) and rotated in a clockwise direction to a home position as illustrated in FIG. 1.

To place the lock cylinder 10 into a learn mode, an authorized key K is inserted into the keyway 18 thereby permitting relative rotation of the cylinder plug 16 within cylinder housing 12 in a clockwise direction as shown in FIG. 7B. Once in the learn position, the cylinder plug 16 may be pushed axially into the interior cavity 14. This axial movement of the cylinder 16 relative to the cylinder housing 12 causes fingers 64 on comb 62 to engage cam surface 70a, thereby rotating pin carrier 36 relative to inner pin 38 to uncouple these components of the pin tumbler assembly 34. At this point, key K is withdrawn from keyway 18. The absence of key K in keyway 18 allows pin carrier 36 and inner pin 38 to slide relative to one another in opposite directions such that the height of tumbler pin assemblies 34 are reset. Next, a new key is inserted into keyway 18 causing inner pin 38 to move with respect to pin carrier 36, thereby adjusting the height of the tumbler pin assembly 34 to configure the lock cylinder 10 so as to be operable by the new key. At this point, cylinder plug 16 is moved axially with respect to cylinder housing 12 and rotated in a counterclockwise direction back to the home position. Through this operation, lock cylinder 10 has been rekeyed to be operable with a new key.

The present invention has been described with reference to a preferred embodiment. However, one skilled in the art will recognize that the present invention may be modified without departing from the spirit and scope of the invention. For example, the preferred embodiment discloses a camming system for rotating the pin carrier with respect to the inner pin. However, other suitable mechanisms may be utilized which provide relative rotation of the pin carrier within the cylinder plug bore. By way of example, the comb 62 may be replaced by suitable gear rack which engages a set of gear teeth formed on the outer surface of the pin carrier for providing relative rotation. Similarly, since the present invention contemplates relative rotation between the pin carrier and the inner pin, other suitable mechanisms may be provided which rotate the inner pin with respect to the pin carrier. Likewise, the present invention has been illustrated as a five pin lock cylinder. However, one skilled in the art will readily recognize that the teachings of the present invention may be readily applied to provide any number of pin assemblies as dictated by the requirements of a given application.

Accordingly, the description of the invention is merely exemplary in nature and, thus, variations that do not depart from the gist of the invention are intended to be within the scope of the invention. Such variations are not to be regarded as a departure from the spirit and scope of the invention.

What is claimed is:

1. A lock cylinder assembly comprising:
a cylinder housing having a first pin bore formed therein which terminates at an interior cavity;
a first tumbler pin disposed in said first pin bore and slidably supported therein;
a cylinder plug having a keyway formed along a longitudinal axis thereof and a second pin bore formed therein and extending between said keyway and an outer surface of said cylinder plug, said cylinder plug rotatably supported within said interior cavity such that said first and second pin bores are aligned when said cylinder plug is in a first position;
a second tumbler pin assembly including:
a second pin disposed and slidably supported within said second pin bore;
a third pin disposed and slidably supported within said second bore subjacent to said second pin;
a coupling element interposed between said second and third pin such, said coupling element being selectively rotatable with respect to at least one of said second and third pins between a coupled position wherein said second pin is fixed to said third pin and a free position wherein said second pin is free from said third pin for varying a height of said second tumbler pin assembly.

2. The lock cylinder of claim 1 wherein said second pin comprises a first end portion at least partially disposed within said third pin and a second end portion opposite said first end portion extending towards said keyway.

3. The lock cylinder of claim 2 wherein said second tumbler pin assembly further comprises a spring biasing said second and third pins away from each other.

4. The lock cylinder of claim 2 wherein said third pin comprises a carrier portion receiving said first end portion of said second pin.

5. The lock cylinder of claim 4 wherein said third pin comprises a pin extension extending from said carrier portion away from said second pin.

6. The lock cylinder of claim 2 wherein said coupling element comprising a first set of teeth formed on a first radial surface of said first end portion and a second set of teeth formed on a second radial surface of said third pin, wherein said first and second sets of teeth are uncoupled upon rotation of said second pin relative to said third pin.

7. The lock cylinder of claim 6 wherein said second set of teeth are formed in about 90° of said second radial surface.

8. The lock cylinder of claim 1 wherein at least one of said second pin and said third pin has a cam arm extending radially outwardly therefrom for rotating said coupling element between said coupled position and said free position.

9. The lock cylinder of claim 8 further comprises an actuator extending into said cylinder plug and engaging said cam arm, said cam arm being movable with respect to said cylinder plug for rotating said rotating said coupling element between said coupled position and said free position.

10. The lock cylinder of claim 1 further comprising:
a set of first tumbler pins, each of said set of first tumbler pins disposed in a corresponding first pin bore and slidably supported therein; and
a set of second tumbler pin assemblies, each of said set of second tumbler pin disposed in a corresponding second bore and slidably supported therein.

11. A lock cylinder assembly comprising:
a cylinder housing having a wall member defining an interior cavity and a first pin bore formed in said wall member and terminating at said interior cavity;
a first tumbler pin disposed in said first pin bore and slidably supported therein;
a cylinder plug having a keyway formed along a longitudinal axis thereof and a second pin bore formed therein and extending between said keyway and an outer surface of said cylinder plug, said cylinder plug rotatably supported within said interior cavity such that said first and second pin bores are aligned when said cylinder plug is in a first position;
a second tumbler pin assembly including a second pin and a third pin disposed in said second pin bore and slidably supported therein, said second pin being selectively rotatable with respect to said third pin between a coupled position wherein said second pin is fixed to said third pin and a free position wherein said second pin is free from said third pin for varying a height of said second tumbler pin assembly.

12. The lock cylinder of claim 11 wherein said second pin comprises a first end portion at least partially disposed within said third pin and a second end portion opposite said first end portion extending towards said keyway.

13. The lock cylinder of claim 12 wherein said second tumbler pin assembly further comprises a spring biasing said second and third pins away from each other.

14. The lock cylinder of claim 12 wherein said third pin comprises a carrier portion receiving said first end portion of said second pin.

15. The lock cylinder of claim 14 wherein said third pin comprises a pin extension extending from said carrier portion away from said second pin.

16. The lock cylinder of claim 12 further comprising a first set of teeth formed on a first radial surface of said first end portion and a second set of teeth formed on a second radial surface of said third pin, wherein said first and second sets of teeth are uncoupled upon rotation of said second pin relative to said third pin.

17. The lock cylinder of claim 16 wherein said second set of teeth are formed in about 90° of said second radial surface.

18. The lock cylinder of claim 11 wherein at least one of said second pin and said third pin has a cam arm extending radially outwardly therefrom for rotating said coupling element between said coupled position and said free position.

19. The lock cylinder of claim 18 further comprises an actuator extending into said cylinder plug and engaging said cam arm, said cam arm being movable with respect to said cylinder plug for rotating said rotating said coupling element between said coupled position and said free position.

20. The lock cylinder of claim 11 further comprising:
a set of first tumbler pins, each of said set of first tumbler pins disposed in a corresponding first pin bore and slidably supported therein; and
a set of second tumbler pin assemblies, each of said set of second tumbler pin disposed in a corresponding second bore and slidably supported therein.

21. A method of rekeying a lock cylinder comprising:
inserting a valid key into a keyway in a cylinder plug;
rotating said cylinder plug with respect to a cylinder housing from a home position to a learn position;
rotating a pin assembly within a pin bore formed in said cylinder plug to a free position such that a height defined by first and second pins of said pin assembly is adjusted;
extracting said valid key from said keyway;
inserting a replacement key in said keyway;
rotating said pin assembly within said pin bore to a coupled position to fix said height;
rotating said cylinder plug to said home position; and
removing said replacement key.

21. The method of claim 20 wherein rotating a pin assembly comprises moving an actuator to engage said pin assembly such that said first pin rotates relative to said second pin.

22. The method of claim 21 where said cylinder plug is slid relative to said actuator for rotating said first pin relative to said second pin.
